(19) United States
(12) Patent Application Publication
(10) Pub. No.: US 2026/0063771 A1
(43) Pub. Date: Mar. 5, 2026

(54) LOW POWER SINGLE PHOTON AVALANCHE DIODE PHOTON COUNTER WITH PEAK CURRENT SUPPRESSION TECHNIQUE

(71) Applicant: OMNIVISION TECHNOLOGIES, INC., Santa Clara, CA (US)

(72) Inventors: Rui Wang, San Jose, CA (US); Tiejun Dai, Santa Clara, CA (US)

(21) Appl. No.: 18/820,017

(22) Filed: Aug. 29, 2024

(51) Int. Cl. G01S 7/4863; G01S 7/481; G01S 7/4865

(52) U.S. Cl. CPC G01S 7/4863; G01S 7/4816; G01S 7/4865

(57) ABSTRACT

A sensor for time of flight calculation, including a laser configured to emit a plurality of pulses of light at a target, one or more SPADs configured to detect a TDC trigger event, where the first TDC trigger event includes one or more photons detected as an initial pulse of light of the plurality of pulses of light is reflected to the one or more SPADs, a counter configured to count the one or more photons of the first TDC trigger event and generate a first histogram of the one or more photons at a first resolution, a global window processor configured to read the first histogram and detect a peak of the first histogram, and a global histogram processor configured to detect a peak of the second histogram, wherein the peak of the second histogram determines a distance between the sensor and the target.

### BACKGROUND INFORMATION

### Field of the Disclosure

This disclosure relates generally to the design of image sensors, and in particular, relates to image sensors configured to make time of flight calculations.

### Background

Image sensors have become ubiquitous. They are widely used in digital still cameras, cellular phones, security cameras, as well as medical, automotive, and other applications. The technology for manufacturing image sensors continues to advance at a great pace. For example, the demands for higher image sensor resolution and lower power consumption motivate further miniaturization and integration of image sensors into digital devices.

Image sensor operates in response to image light coming from an external scene and being incident upon the image sensor. An image sensor includes an array of pixels having photosensitive elements (e.g., photodiodes) that absorb a portion of the incident image light and in response generate corresponding electrical charge. The electrical charge of individual pixels may be measured as an output voltage of each photosensitive element. In general, the output voltage varies as a function of the intensity and duration of the incident light. The output voltage of individual photosensitive elements is used to produce a digital image (i.e., image data) representing an external scene.

In some applications, photodiodes may be used to determine time of flight (ToF) calculations. Conventionally, this may be accomplished by detecting a peak of a histogram representative of photodiode trigger events. However, histogram peak detection requires additional hardware that may be costly, or very large in comparison to the image sensor. Further, generated histograms can also include noise and the timing resolution may be degraded when a wider laser pulse is detected.

Additionally, photon pileups, which can cause distortion of histograms, are also a common occurrence. Photon pileup occurs because a single-photon avalanche diode (SPAD) ends up capturing an ambient light photon almost immediately after each laser pulse transmission, with overwhelmingly high probability. As a result, the true signal peak gets buried in the tail of this pileup distortion, therefore resulting in large depth errors. While the peak usually can be estimated through the histogram, if the histogram is not entirely normal/Gaussian, then only the peak bin may be used, as the center of mass may not be the same as the actual ToF, due to histogram distortion caused by the ambient noise and pileup distortion.

Therefore, systems and methods are needed for improved determination of time of ToF.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1A is an example time of flight (ToF) measurement setup, in accordance with the present technology.

FIGS. 1B-1C show example simple histogram peak detection, in accordance with the present technology.

FIGS. 2A-2D are example digital conversion histograms, in accordance with the present technology.

FIG. 3A is an example image sensor, in accordance with the present technology.

FIG. 3B is an example coarse to fine histogram time to digital conversion, in accordance with the present technology.

FIG. 3C is example Gray automatic exposure code (GAEC), in accordance with the present technology.

FIG. 3D is an example delay line circuit, in accordance with the present technology.

FIG. 3E is an example global histogram processing circuit, in accordance with the present technology.

FIG. 3F is an example clock (CLK) circuit, in accordance with the present technology.

FIG. 3G is an example clock delay line circuit, in accordance with the present technology.

FIG. 4A is an example image sensor, in accordance with the present technology.

FIG. 4B is an example digital conversion histogram with single photon avalanche diode (SPAD) gating, in accordance with the present technology.

FIG. 5 is an example method of calculating a time of flight (ToF) measurements, in accordance with the present technology.

FIG. 6 is another example method of calculating a time of flight (ToF) measurements, in accordance with the present technology.

FIG. 7 is yet another example method of calculating a time of flight (ToF) measurements, in accordance with the present technology.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Image sensors, and in particular, image sensors that include color routers are disclosed. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one example” or “one embodiment” means that a particular feature, structure, or characteristic described in connection with the example is included in at least one example of the present invention. Thus, the appearances of the phrases “in one example” or “in one embodiment” in various places throughout this specification are not necessarily all referring to the same example. Furthermore, the particular features, structures, or characteristics may be combined in any suitable manner in one or more examples.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

From the foregoing, it will be appreciated that specific embodiments of the technology have been described herein for purposes of illustration, but that various modifications may be made without deviating from the disclosure. Moreover, while various advantages and features associated with certain embodiments have been described above in the context of those embodiments, other embodiments may also exhibit such advantages and/or features, and not all embodiments need necessarily exhibit such advantages and/or features to fall within the scope of the technology. Where methods are described, the methods may include more, fewer, or other steps. Additionally, steps may be performed in any suitable order. Accordingly, the disclosure can encompass other embodiments not expressly shown or described herein. In the context of this disclosure, the terms “about,” “approximately,” etc., mean+/−5% of the stated value.

Throughout this specification, several terms of art are used. These terms are to take on their ordinary meaning in the art from which they come, unless specifically defined herein or the context of their use would clearly suggest otherwise. It should be noted that element names and symbols may be used interchangeably through this document (e.g., Si vs. silicon); however, both have identical meaning.

Briefly, the embodiments of the present technology are directed to image sensors for calculating a time of flight (ToF) measurement from the image sensor to a target. In some embodiments, a first time to digital conversion (TDC) event is detected when a laser emits a plurality of pulses of light at a target. In some embodiments, one or more single photon avalanche diodes (SPADs) detect the first TDC trigger event. In some embodiments, one or more latches latch Gray automatic exposure code (GAEC) from the one or more SPADs, where the GAEC is associated with the first TDC trigger event. In some embodiments, a counter counts the one or more photons of the first TDC trigger event and generates a first histogram of the one or more photons at a first resolution, and a global window processor reads the first histogram and detects a peak of the first histogram. In some embodiments, a window memory controls a single photon avalanche diode (SPAD) controller, where the SPAD controller enables the one or more SPADs to detect a second TDC trigger event, where the second TDC trigger event includes one or more photons detected as an additional pulse of light of the plurality of pulses of light is reflected to the one or more SPADs during a timing of the peak of the first histogram. In some embodiments, a delay line configured to output the one or more photons at a second resolution, where the counter is further configured to generate a second histogram of the one or more photons at the second resolution, and a global histogram processor detects a peak of the second histogram, where the peak of the second histogram determines a distance between the sensor and the target.

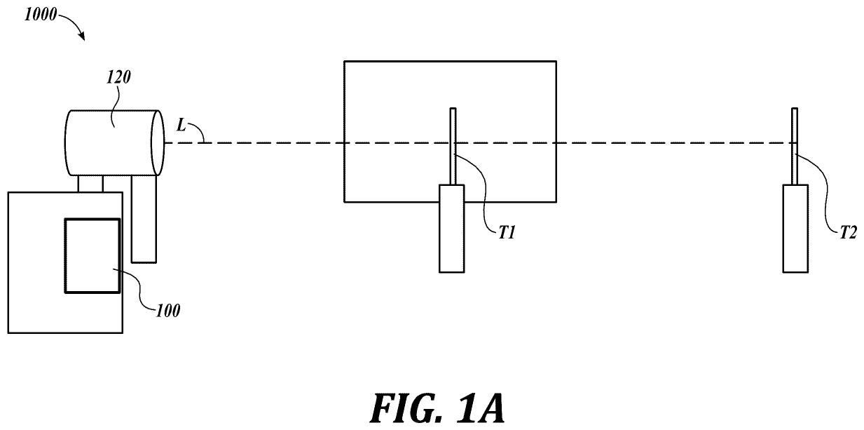

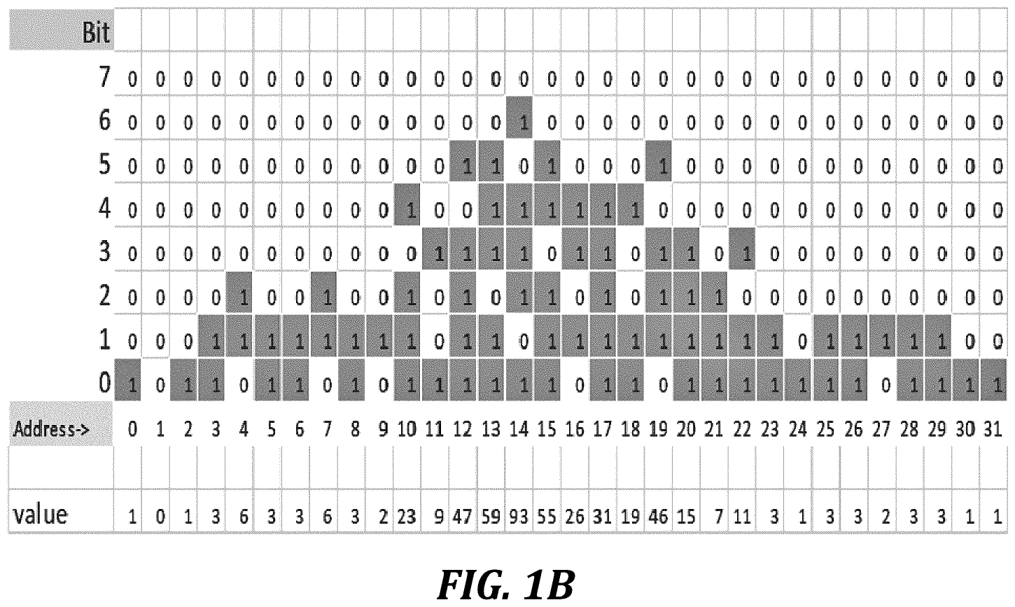

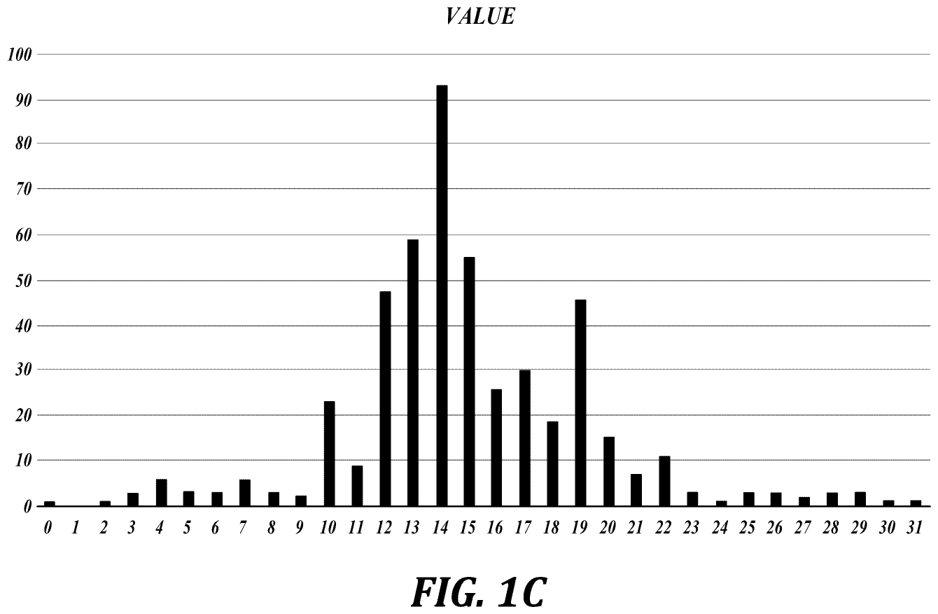

FIG. 1A is an example time of flight (ToF) measurement setup 1000, in accordance with the present technology. In some embodiments, the measurement setup 1000 includes a first target T1, a second target T2, a time to digital conversion (TDC) sensor 100, and a source of light (e.g., a laser) 120. In some embodiments, the laser 120 may be coupled to a diffuser.

In operation, the TDC sensor 100 is operationally coupled to the laser 120. The laser 120 emits light L to the first target T1 and the second target T2. A histogram may be used to extract distance accurately. For example, a separate histogram may be created for the first target T1 and for the second target T2. By determining the peak of each histogram, an accurate distance between the first target T1 and the second target T2 can be calculated.

FIGS. 1B-1C show example simple histogram peak detection, in accordance with the present technology. FIG. 1B shows a hardware implementation of a histogram based on a memory that can capture values of the histogram. As shown in FIG. 1B, the address is an index of the bin, and the data is a histogram value of each bin. In this example, this is a 32-address and an 8-bit word memory. Accordingly, the full range of the capture is only 32 the histogram values, each having an 8-bit resolution.

In a simple peak detection, a histogram bin width corresponds to a timing resolution. Accordingly, a higher resolution requires a wider histogram. Conventionally this results in a higher cost, as additional hardware is needed to increase the histogram bin size. Conventionally, histogram centroid processing may then be applied. In such cases, the timing resolution achieved is much smaller than the histogram bin width, because the peak may end up anywhere within the bin width. Next, floating point data can be extracted, as shown in FIG. 1C. In the illustrated case, a simple peak is detected at bin 14.

Further, while conventional histogram processing can be used to estimate a peak, it requires significant computation to achieve, which is not always possible for each time to digital conversion (TDC). Further, TDC array computation requires high speed data transfer. For example, histogram centroid processing includes multiple calculations. Given N samples of distribution (for the following equations, N=100,000), a sample standard deviation may be calculated as:

$$s = \sqrt{\sum {( {x}_{i} - \overline{x} )}^{2} / ( N - 1 )} \qquad Equation 1$$

Equation 1 is a Bessel's correction using N−1. This equation can then be used to estimate the real standard deviation. The standard error (SE) is the variability of the sample standard deviations from sample to sample. The SE indicates the error from real standard deviation due to random sampling, as shown in equation 2 below.

$$SE = \frac{s}{\sqrt{2 ( N - 1 )}} = \frac{\sqrt{\sum {( {x}_{i} - \overline{x} )}^{2}}}{( N - 1 ) \sqrt{2}} \qquad Equation 2$$

To achieve the calculations above, a large memory and computing effort are needed. However, a histogram can be used to predict the peak/mode of the histogram, which requires less memory for storing the signal. The accuracy of the calculated peak depends on bin width (in terms of sigma), bin size (how many bins, in the illustrated case 32), and histogram bit-width (e.g. 8-bit, histogram count resolution max being 255). As a result, in the illustrated example, only 32×8=256-bit memory is needed for each histogram.

To better predict the peak/mode, the histogram bin width is smaller than sigma and preferably smaller than ⅓ of sigma. For laser pulsed TDC, a bin width from about ⅙ to about ⅓ of laser pulse width may be satisfactory. So, a 2 ns pulse width with a bin size of 300 ps may be acceptable in many cases. Histogram centroid (center of mass) processing can obtain better accuracy than simply choosing the peak bin.

$$C = \frac{\sum moment}{\sum mass} = \frac{\sum mass \cdot position}{\sum mass} \qquad Equation 3$$

The peak can be estimated through the histogram, but if the histogram is not normal/Gaussian, then only the peak bin may be used, as the center of the mass may not be the same as the actual ToF, due to histogram distortion from ambient noise and pileup. The true signal peak gets buried in the tail of this pileup distortion resulting in large depth errors. In this example, this process results in a large distance error when high resolution is demanded.

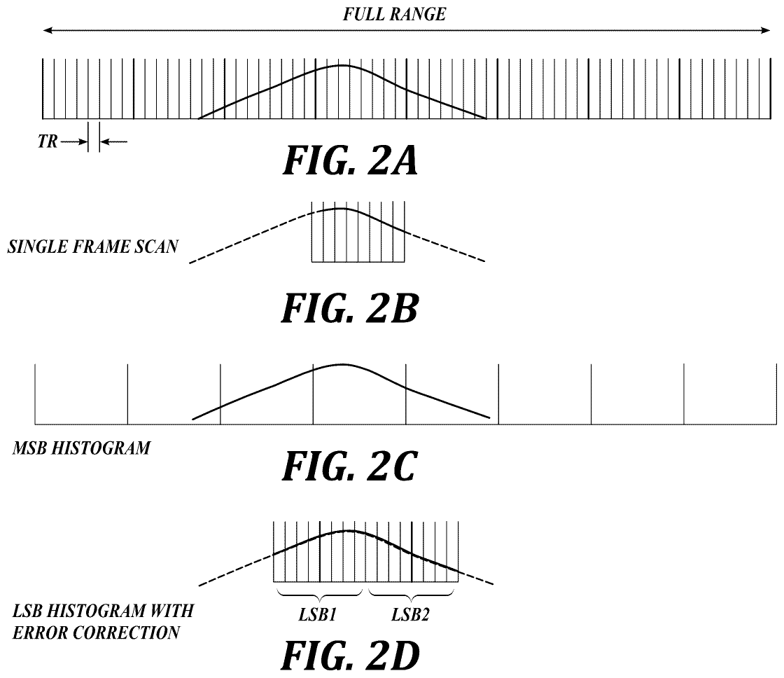

FIGS. 2A-2D are example time to digital conversion histograms, in accordance with the present technology. As another example, in single photon avalanche diode (SPAD) histogram time to digital conversion (TDC) may be used. As explained above, timing resolution is limited by the histogram bin width, provided the histogram is normal/Gaussian.

FIG. 2A is a full histogram. The time resolution TR is illustrated as a series of vertical lines. The full histogram bin resolution may be represented as 2^{Nf}, where N_{f} is the exponent, and the subscript “f” refers to the full histogram. In FIG. 2A, the histogram has a 6-bit depth data, which requires 64 bins.

FIG. 2B is a partial histogram, with a bin resolution represented as 2^{Np}, where Nₚ is the exponent, and the subscript “p” refers to the partial histogram. In some embodiments, multiple scan frames 2^{(Nf-Np)} cover the full range of the full histogram of FIG. 2A. Each scan may have a 3-bit data depth and represent 8 bins. In such an example, 8 scans are executed to cover the entire 64-bin histogram. That is, in the illustrated example, Np=3, and Nf−Np=3.

FIG. 2C shows a most significant bit (MSB) histogram, with a bin resolution represented as 2Nₘ, where Nₘ is the exponent, and the subscript “m” refers to MSB histogram. In one example, as shown in FIG. 2C, Nₘ=3. In some embodiments, a double stage histogram is generated. A first MSB scan of an Nₘ-bit data depth that represents 2Nₘ bins may obtain the MSB bin, then a second scan of an Nₜ-bins in the obtained MSB bin, where Nₜ is decided by the timing resolution, so that Nₜ*timing resolution can fully cover the MSB bin width. The double stage histogram can cover the full range of the full histogram with a total number of scan 2^{Nf} which includes the 2Nₘ-MSB histogram scan, and the Nₜ fine resolution scan. Equation 4 explains this process.

$${N}_{f} = {N}_{m} + {N}_{t} \qquad Equation 4$$

The MSB histogram bin resolution is represented by 2^{Nm}. In one example, a 32-bin histogram is generated, with an 8-bit depth data. Two frames are scanned. In the first frame, the MSB histogram in generated. In the second frame, the least significant bit (LSB) histogram is generated, as shown in FIG. 2D. To generate the LSB histogram, the peak of the MSB histogram is identified and the timing resolution (determined by bin width) for each LSB histogram is determined. The LSB histogram can be represented by Nₗ-bit data depth with 2^{Nl} bins. In some embodiments, Nₜ=2Nₗ. In the example shown in FIG. 2C, for a full histogram of 64-bin, the MSB-LSB double stage histogram only requires 8+8=16 scans, which can save significant scan time.

In FIG. 2D, an LSB histogram, with error correction, bin resolution is represented as 2*2Nt. The double width scan of LSB histogram can avoid error in case the actual data falls at the boundary between two MSB bins. While a double stage TDC does not need as much memory as histogram centroid processing, it requires that an object not be moving quickly. As shown in FIG. 2D, two LSB histograms (LSB1, LSB2) are illustrated. While the methods shown in FIGS. 2A-2D may be used to determine a ToF calculation, they each have drawbacks. Such drawbacks are that the timing resolution is limited by the histogram bin width. Further, the target cannot be moving quickly, or the histogram will be generated improperly. These methods can also result in long processing times, require additional hardware, and consume large amounts of power.

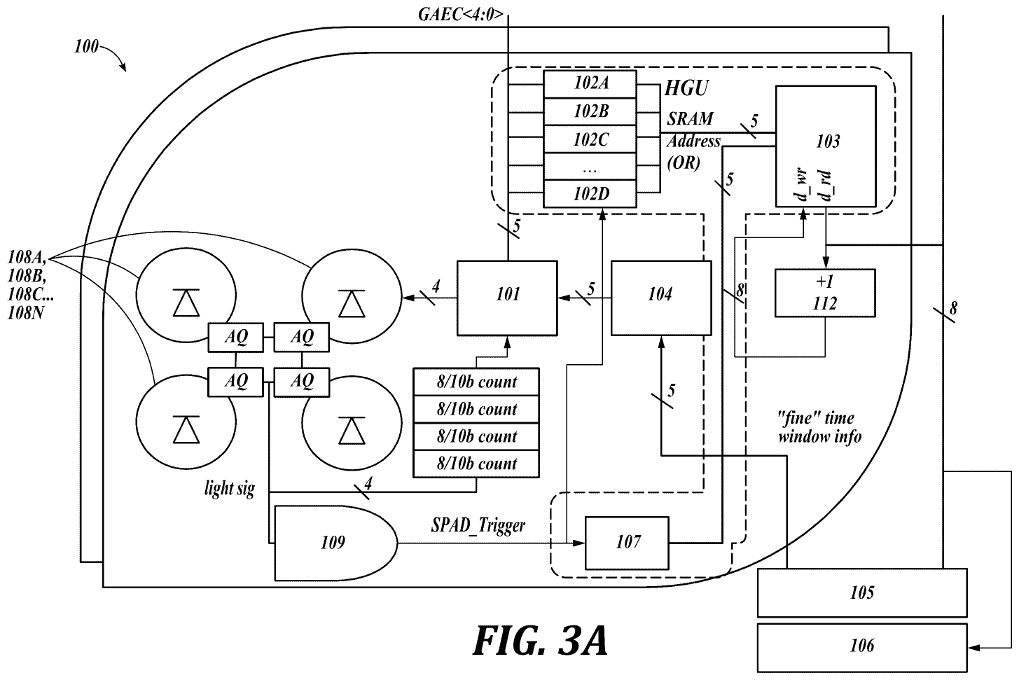

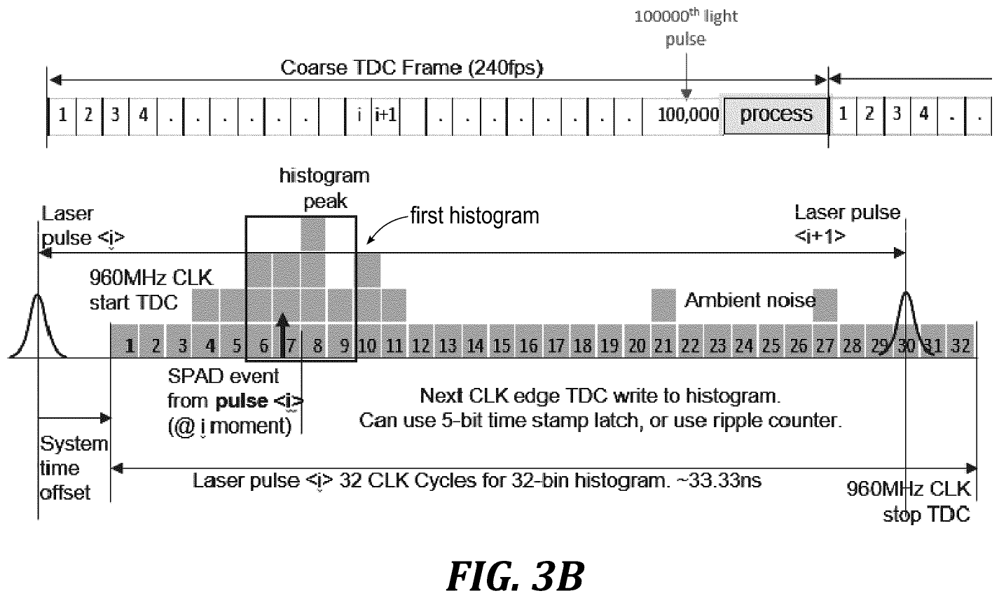

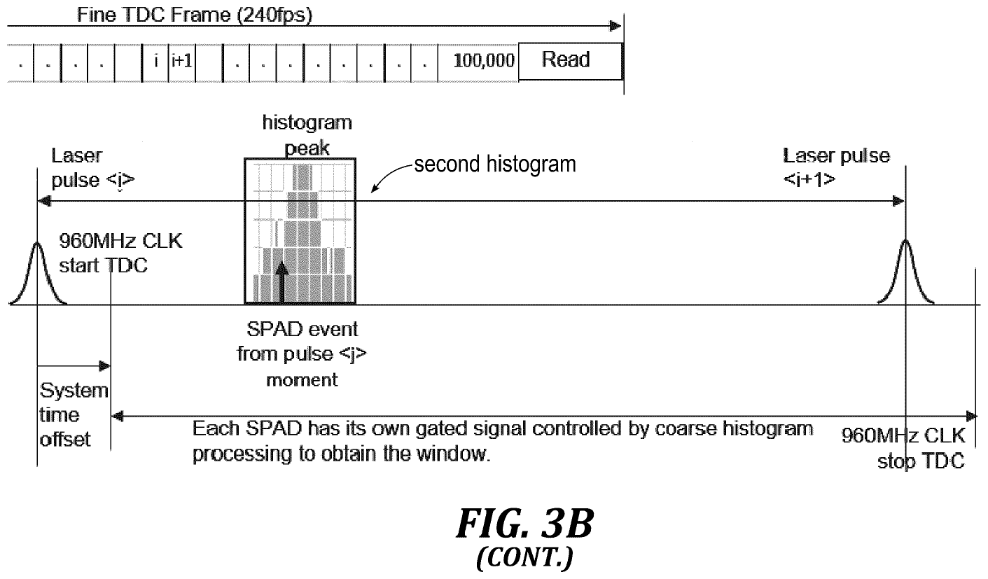

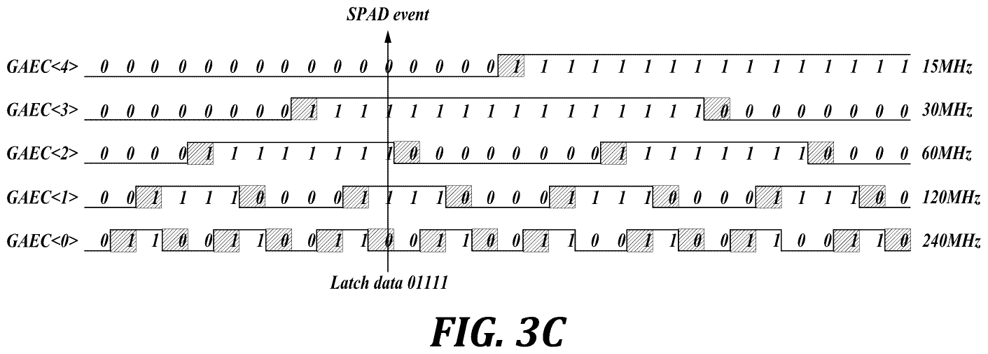

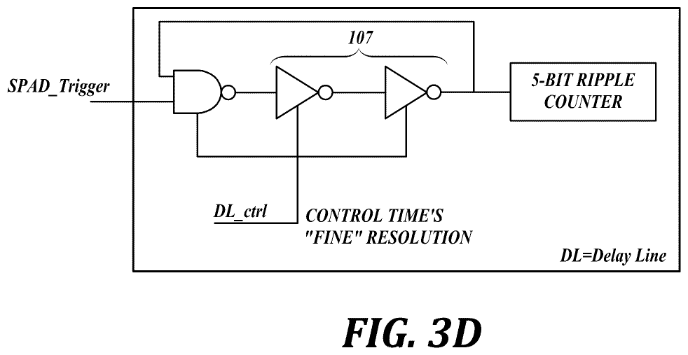

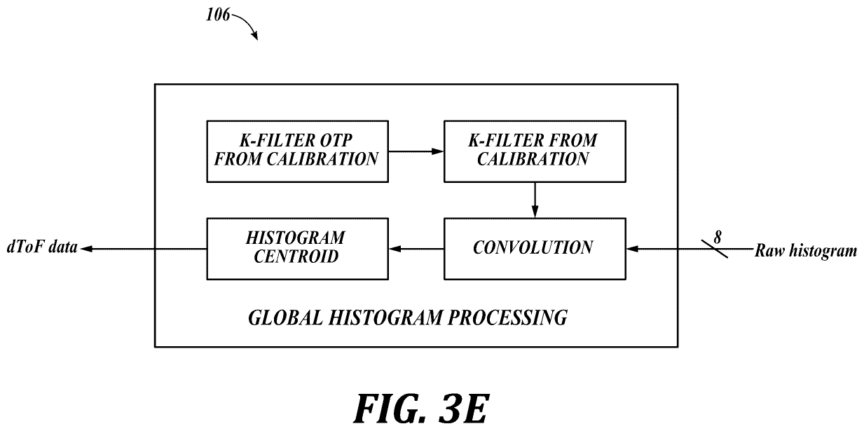

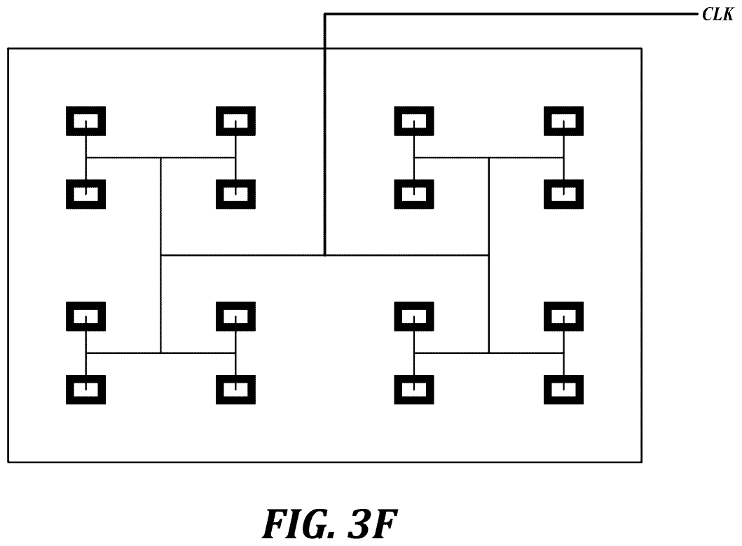

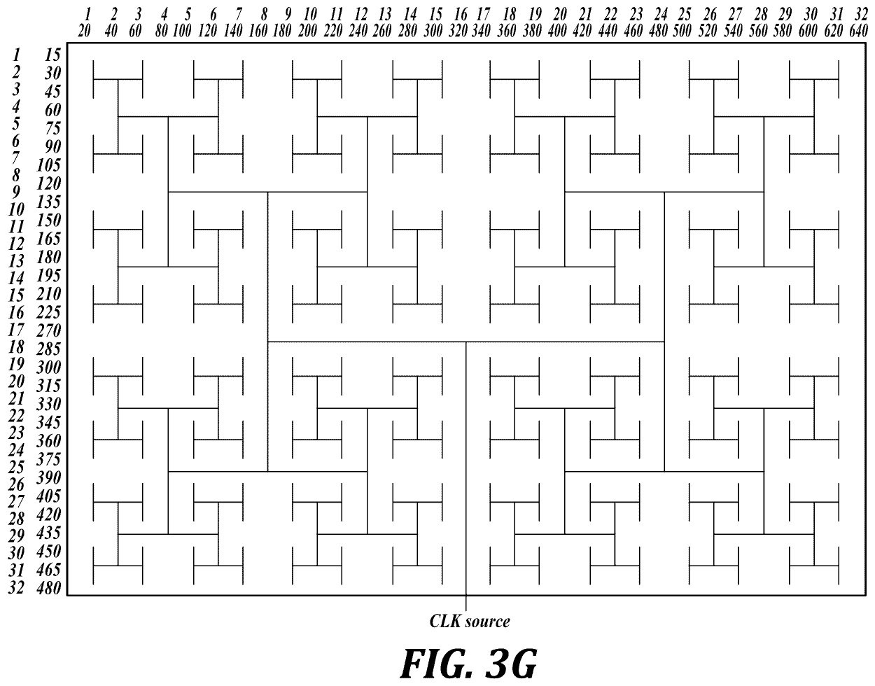

FIG. 3A is an example image sensor 100, in accordance with the present technology. In some embodiments, the image sensor 100 includes a single photon avalanche diode (SPAD) controller 101, a plurality of latches 102A, 102B, 102C . . . 102D, a memory 103, a window memory 104, a global window processing 105, a global histogram processing 106, a delay line 107, a counter 112, and a plurality of single photon avalanche photodiodes (SPADs) 108A, 108B, 108C . . . 108N.

In some embodiments, each SPAD of the one or more SPADs 108A, 108B, 108C . . . 108N is communicatively coupled to an active quenching circuit AQ. In some embodiments, the one or more SPADs 108A, 108B, 108C . . . 108N are four SPADs. In some embodiments, the four SPADs 108A, 108B, 108C . . . 108N are arranged in a two-by-two array.

In some embodiments, the delay line 107 is a clock (CLK) counter. The CLK counter may be selected from a high-speed CLK counter and a low-speed CLK counter.

In operation, a laser (such as laser 120) emits a plurality of pulses of light at a target. In some embodiments, the target is a first target (such as target T1) and a second target (such as target T2) as shown in FIG. 1A. In some embodiments, the SPADs 108A, 108B, 108C . . . 108N detect a first time to digital conversion (TDC) trigger event, where the first TDC trigger event includes one or more photons detected as an initial pulse of light of the plurality of pulses of light is reflected to the one or more SPADs. In some embodiments, the one or more latches 102A, 102B, 102C . . . 102D latch Gray automatic exposure code (GAEC) from the one or more SPADs 108A, 108B, 108C . . . 108N, where the GAEC is associated with the first TDC trigger event. In some embodiments, the memory 103 is configured to read static random-access memory (SRAM) addressed by the GAEC, and the counter 112 counts the photons of the first TDC trigger event to generate a first histogram of the one or more photons at a first resolution (as shown in FIG. 3B).

In some embodiments, the global window processor 105 reads the first histogram and detects a peak of the first histogram. The window memory 104 may then control the SPAD controller 101 as follows. The SPAD controller 101 enables the one or more SPADs 108A, 108B, 108C . . . 108N to detect a second TDC trigger event, where the second TDC trigger event includes one or more photons detected as an additional pulse of light of the plurality of pulses of light is reflected to the one or more SPADs 108A, 108B, 108C . . . 108N during a timing of the peak of the first histogram.

The delay line 107 may output one or more photons at a second resolution, where the counter 112 generates a second histogram of the one or more photons at the second resolution. In some embodiments, the global histogram processor 106 is configured to detect a peak of the second histogram, where the peak of the second histogram determines a distance between the sensor 100 and the target.

In some embodiments, the second resolution is higher than the first resolution. In some embodiments, the second histogram comprises the first target histogram at the second resolution and the second target histogram at the second resolution. In some embodiments, a peak of the first target histogram at the first resolution and a peak of the second target histogram at the second resolution are compared to calculate a distance between the first target and the second target.

FIG. 3B is an example of a coarse-fine histogram time to digital conversion (TDC), in accordance with the present technology. Along the top of FIG. 3A is the time to digital conversion (TDC) frame. In some embodiments, the first histogram has a first resolution and the second histogram has a second resolution. In some embodiments, the second resolution is higher than the first resolution. In such embodiments, the first histogram may be referred to as a “coarse” histogram (i.e., having a lower resolution) and the second histogram may be referred to as a “fine” histogram (i.e., having a higher resolution). The TCD histograms (both the first histogram and the second histogram) are shown between a first laser pulse <i> and a second laser pulse <i+1>. As shown in FIG. 3B, there are 32 clock (CLK) cycles for a 32-bin coarse histogram. In some embodiments, total length of data acquisition takes about 33.3 ns.

In operation the system may have a predetermined system time offset. In some embodiments, the coarse histogram is associated with a first single photon avalanche diode (SPAD) trigger event from the first laser pulse <i>. In some embodiments, a peak of the coarse histogram is generated at a TDC frame “i”. In some embodiments, a next CLK edge of the CLK signals determines the time of data acquisition and a location of the bin within the histogram. In some embodiments, the bin/edge location is determined with a 5-bit time stamp latch. In other embodiments, the bin/edge location is determined with a ripple counter. In some embodiments, the CLK signal is generated at 960 MHz. After 32 CLK cycles, the TDC is stopped. In some embodiments, the coarse histogram is readout and processed with global window processing. As used herein, global window processing takes the readout coarse histogram and determines a ‘window’ near the peak of the readout histogram. This window is then processed with global histogram processing to generate the fine histogram. In some embodiments, the coarse histogram is written back to control a SPAD controller (such as SPAD controller 101) for the next fine histogram TDC frame.

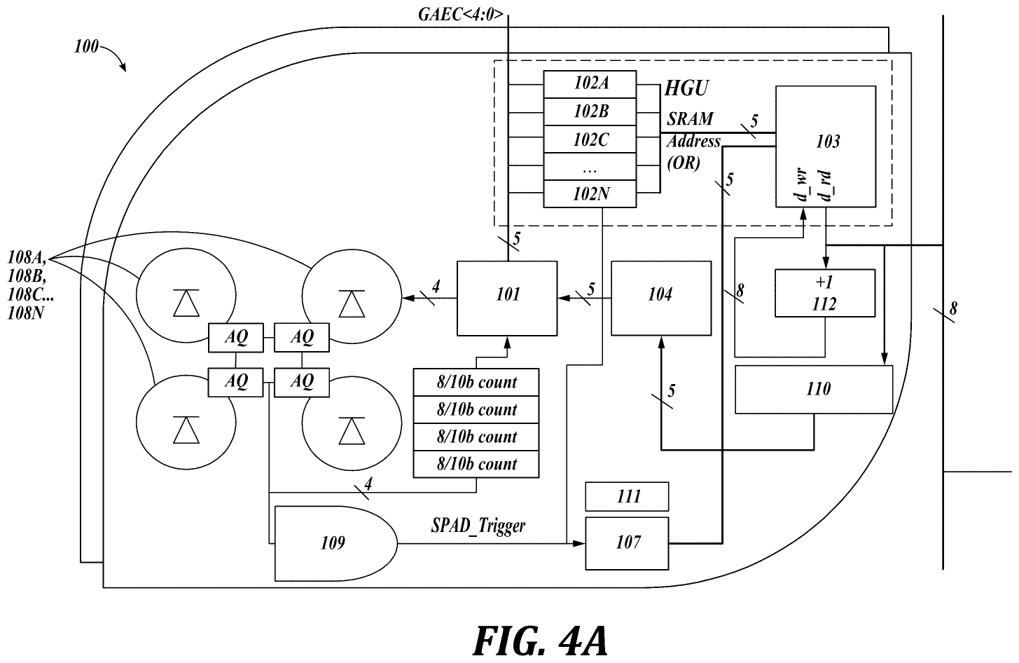

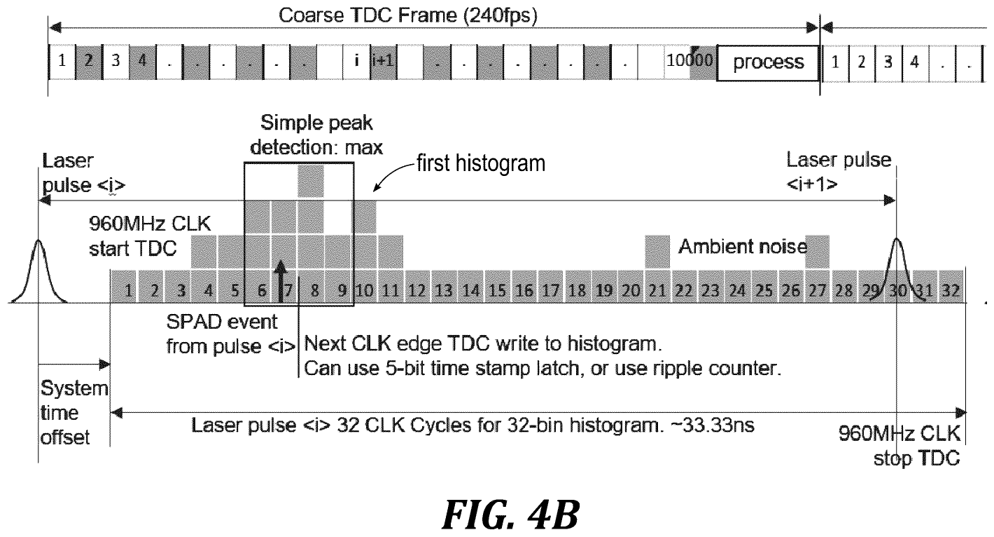

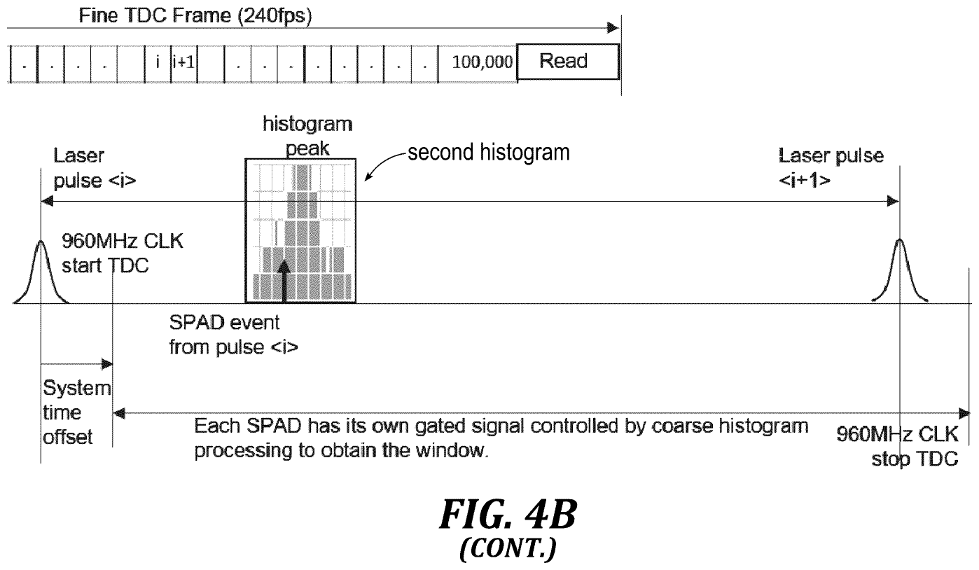

In operation, the fine histogram may be generated after the coarse histogram. While the coarse histogram and the fine histogram are shown on separate axes, it should be understood that the coarse histogram and the fine histogram occur on a similar time scale, as shown by the TDC frames above. In some embodiments, the fine histogram is generated between a laser pulse <i> and a laser pulse <i+1>, at time <j>. In some embodiments, the fine histogram is generated at a frame after frame “i” in time. The resolution of data acquisition is higher within the fine histogram (as opposed to the coarse histogram). This is beneficial because the fine histogram provides a more “Gaussian-like” histogram, which makes the later centroid processing calculation more accurate, as described herein. In some embodiments, the fine histogram is a “zoomed in” view of a specific window near the peak of the coarse histogram, which can save power as most ambient light artifacts are removed. The fine resolution photon detection efficiency (PDE) may also be more stable, as the window is used to quench SPADs. In some embodiments, each SPAD has its own gated signal controlled by a coarse histogram processing (as shown in FIG. 4B) to obtain the window, as explained herein.

FIG. 3C is example Gray automatic exposure code (GAEC), in accordance with the present technology. GAEC may also be referred to as “Gray code” herein. The vertical line represents a SPAD event.

In some embodiments, such as shown in FIG. 3C, GAEC obtained at multiple frequencies (15 MHz, 30 MHz, 60 MHz, 120 MHz, 240 MHz) is latched. In some embodiments, a sensor comprising arithmetic logic is configured to detect one or more coincident event, where the GAEC is further based on the one or more coincident event. A coincident event occurs when two photons belonging to different events reach the photon detector within a same (or “coincidence”) time window. In such embodiments, measurements of this chance event may be difficult to separate from measurements of target events (such as SPAD trigger events). The higher the timing resolution of the coincidence detector, the easier it is to discriminate between coincident events and true signals. In some embodiments, the coarse histogram uses gray code for the memory address. In some embodiments, the GAEC results in less latch data errors. The arrow represents a SPAD event at latch data 01111. Accordingly, in the example in FIG. 3C, there is a signal at 30 MHz, 60 MHz, and 120 MHz, but there is no signal present for 15 MHz or 240 MHz. In this manner, the memory address is determined. In some embodiments, the fine histogram uses binary code for the memory address.

FIG. 3D is an example delay line circuit, in accordance with the present technology. In some embodiments, the delay line 107 is coupled with a 5-bit ripple counter. A typical implementation of the delay line 107 may include several drivers coupled in series. In some embodiments, in response to a SPAD TDC trigger, the delay line controller DL_ctrl controls the time's fine resolution, for the second histogram. The 5-bit ripple counter may then generate the second histogram.

FIG. 3E is an example global histogram processing circuit (or global histogram processor) 106, in accordance with the present technology. In some embodiments, the global histogram processor 106 is further configured to determine the peak of the second histogram with histogram centroid processing, as described herein. In some embodiments, the global histogram processor 106 is configured to generate a one-time programmable (OTP) K-Filter, a K-Filter from calibration, convolution, and histogram centroid processing of the raw histogram from the memory (such as memory 103). In some embodiments, each of these steps is considered “histogram processing.” The global histogram processor then sends the processed data to the window memory (such as window memory 104). In this manner, even if histogram centroid processing is used, it can be accomplished with less cost and without additional, large hardware.

FIG. 3F is an example clock (CLK) circuit, in accordance with the present technology. In some embodiments, the CLK counter is a low speed CLK counter. In some embodiments, one-branch of an H-tree share one general DL ctrl, which can be controlled through calibration, so the time step is fixed and not affected by process, voltage, or temperature (PVT). Since the length of each of the branches of the transmission line from the CLK source to each of the termination points of the H-tree line is constant, the transmission line delays for such plurality of branches are also constant. In such embodiments, the circuit may use a slower reference CLK.

FIG. 3G is an example clock delay line circuit, in accordance with the present technology. When used to generate histograms, the power from the SPADs and counter may be reduced. This is due to a single CLK source being used, as opposed to multiple CLKs. In some embodiments, the CLK counter is a high speed CLK counter. Even with a high speed CLK, all TDCs need to be reached, which means that power consumption remains high.

In some embodiments, the CLK may be coupled with a delay locked loop (DLL), with an H-tree (as shown in FIG. 3G). In such embodiments a DLL is not used for each TDC. Instead, each group of TDC can share the DLL. In some embodiments, the DLL includes a signal processing element, such as a flat amplifier or an integrator. In some embodiments, the CLK is of the 0^{th} order type 0 or a 1^{st} order type 1 DLL. Generally, given enough time, the DLL will synchronize different events and/or frequencies. In this manner, the DLL creates a basis for a CLK with a reduced frequency.

In one example, the image sensor includes a 640×480 array, having one TDC per 2×2 pixels of the array, and one photon counter (PC) per pixel. The H-tree smallest unit is set to 40×30, therefore there is one DLL for every 40×30 TDC. In such embodiments, a low speed CLK can be used, distributed to the 40×30 TDC units. Then, the DLL may be generated locally, and the delay line may latch the DLL signals. In such embodiments, the CLK power may be less compared with using global DLL to generate a high speed CLK and then distribute the high speed CLK to each TDC unit.

In the example of a 648×480 array with 40×30 TDC units, one DLL power is P1, and the CLK tree power for low frequency f is P0, then the total power of the CLK tree including the 1200 local DLLs is P0+1200*P1. A high frequency CLK is N*f, and the power of the CLK tree to distribute the high frequency CLK is N*P0+P1. When P0>1199/(N−1)*P1, using low speed clock with local DLL has less CLK tree power, for example, when N=128, f=7.5 MHz, and N*F=960 MHz. Distribution of a low speed 7.5 MHz CLK with local DLL is P0+1200*P1. Distribution of a high speed 960 MHz CLK power is 128*P0+P1. When P0>9.44*P1, using a low speed CLK has less CLK tree power. Usually, the whole CLK tree capacitive loading is very large, and power consumption of the CLK tree P0 can be much larger than the power consumption of one local DLL, or P0>>P1.

In other embodiments, a high speed CLK may be locally generated, and the counter may be used only for the fine TDC histogram, as opposed to the coarse histogram. A voltage infrared (IR) drop on power supplies of the system may cause global CLK distribution delays and/or jitters, which result in timing detection error at different pixel locations. This can be avoided by using local DLL. The Local DLL can correct the timing error compared to a global DLL. Further, calibration controls can be stored locally for each DLL.

FIG. 4A is an example image sensor 100, in accordance with the present technology. In some embodiments, the image sensor 100 includes a single photon avalanche diode (SPAD) controller 101, a plurality of latches 102A, 102B, 102C . . . 102D, a memory 103, a window memory 104, a global window processing 105, a delay line 107, a counter 112, a plurality of single photon avalanche photodiodes (SPADs) 108A, 108B, 108C . . . 108N, a coincident detection 109, a local window processor 110, and a calibrator 111.

In some embodiments, the image sensor 100 uses the local window processor 110 to find the bin with the largest address. In such embodiments, no histogram readout of centroid computation is needed. Accordingly, under strong lighting conditions, not all SPADs need to be operating, which results in a reduction of peak current. Similarly, in low lighting conditions, all SPADs can be operated, to improve image quality.

In operation, the local window processor 110 may then find the bin with the largest address. In such embodiments, no histogram readout or centroid computation is used. The delay line may output the one or more photons at a second resolution. In some embodiments, the delay line 107 includes a calibrator 111, as shown and described in FIG. 3G.

FIG. 4B is an example time to digital conversion with single photon avalanche diode (SPAD) gating, in accordance with the present technology.

In some embodiments, the SPAD controller (such as SPAD controller 101) is used to gate the SPADs so after-pulsing is suppressed to a lower level. In such embodiments, the histogram peak detection can be a simple max detection using local logic circuits for the coarse TDC, so the process time at the end of each coarse TDC frame can be reduced. In such embodiments, an access global bus is not needed to readout the first histogram to obtain a window for second TDC histogram. Instead of using a global histogram processor (such as shown in FIG. 3A), the local window processor finds the bin with the largest address. In such embodiments, no histogram readout or centroid computation is needed.

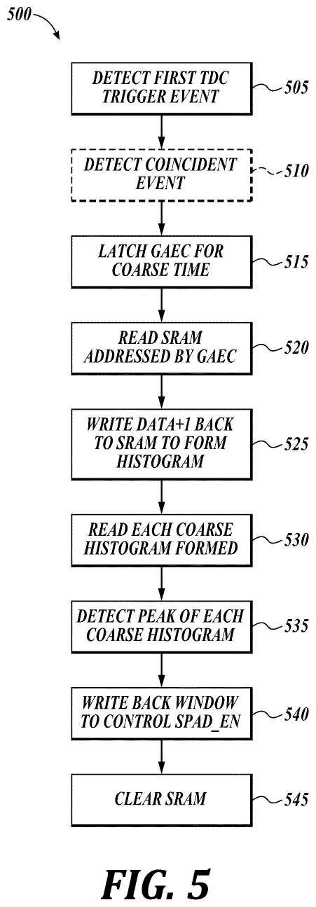

FIG. 5 is an example method 500 of calculating a time of flight (ToF) measurements, in accordance with the present technology. In some embodiments, the method 500 is carried out with an image sensor (such as image sensor 100). In some embodiments, the image sensor includes a single photon avalanche diode (SPAD) controller (such as SPAD controller 101), a plurality of latches (such as plurality of latches 102A, 102B, 102C . . . 102D), a memory (such as memory 103), a window memory (such as window memory 104), a global window processor (such as global window processor 105), a global histogram processor (such as global histogram processor 106), a delay line (such as delay line 107), a counter (such as counter+1), and a plurality of single photon avalanche photodiodes (SPADs) (such as plurality of SPADs 108A, 108B, 108C . . . 108N).

In block 505, a first TDC trigger even is detected. In some embodiments, the first TDC trigger event includes one or more photons being detected as an initial pulse of light of the plurality of pulses of light is reflected to the one or more SPADs. In some embodiments, the pulse of light is emitted by a laser (such as laser 120).

In block 510, optionally, a coincident event is detected. In some embodiments, the coincident event is detected by a coincident detector (such as coincident detector 109). As explained herein, a coincident event occurs when two photons belonging to different events reach the photon detector within a same (or “coincidence”) time window. In such embodiments, measurements of this chance event may be difficult to separate from measurements of target events (such as SPAD trigger events). The higher the timing resolution of the coincidence detector, the easier it is to discriminate between coincident events and true signals.

In block 515, Gray automatic exposure code (GAEC) is latched for coarse data acquisition. In some embodiments, one or more latches are configured to latch Gray automatic exposure code (GAEC) from the one or more SPADs, where the GAEC is associated with the first TDC trigger event.

In block 520, static random-access memory (SRAM) addressed by the GAEC is addressed. In some embodiments, the memory is configured to read the SRAM addressed by the GAEC.

In block 525, data+1 is written back to the SRAM to form a first histogram. In some embodiments, the first histogram has a first resolution. In some embodiments, the first histogram is a coarse histogram. In some embodiments, the counter is configured to count the one or more photons of the first TDC trigger event and generate a first histogram of the one or more photons at a first resolution.

In block 530, each coarse histogram formed is read. In some embodiments, a coarse histogram is generated for every TDC event.

In block 535, a peak of each coarse (or first) histogram is detected. In some embodiments, the global window processor is configured to read the first histogram and detect a peak of the first histogram.

In block 540, a window to control the SPAD controller (SPAD_EN) is written back. In some embodiments, the window memory is configured to control a single photon avalanche diode (SPAD) controller, where the SPAD controller enables the one or more SPADs to detect a second TDC trigger event, where the second TDC trigger event includes one or more photons detected as an additional pulse of light of the plurality of pulses of light is reflected to the one or more SPADs during a timing of the peak of the first histogram.

In block 545, the SRAM is cleared.

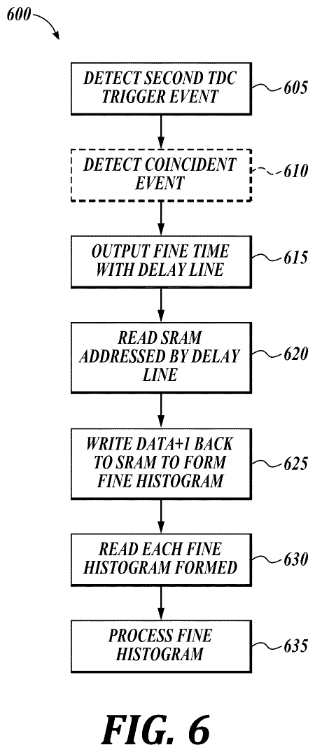

FIG. 6 is another example method of calculating a time of flight (ToF) measurements, in accordance with the present technology. In some embodiments, the method 600 is carried out with an image sensor (such as image sensor 100). In some embodiments, the image sensor includes a single photon avalanche diode (SPAD) controller (such as SPAD controller 101), a plurality of latches (such as plurality of latches 102A, 102B, 102C . . . 102D), a memory (such as memory 103), a window memory (such as window memory 104), a global window processer (such as global window processor 105), a global histogram processer (such as global histogram processor 106), a delay line (such as delay line 107), a counter (such as counter+1), and a plurality of single photon avalanche photodiodes (SPADs) (such as plurality of SPADs 108A, 108B, 108C . . . 108N). In some embodiments, method 600 occurs directly after method 500.

In block 605, a second trigger event is detected, different from the first trigger event detected in block 505 of FIG. 5. In some embodiments, the SPAD controller enables the one or more SPADs to detect a second TDC trigger event, wherein the second TDC trigger event includes one or more photons detected as an additional pulse of light of the plurality of pulses of light is reflected to the one or more SPADs during a timing of the peak of the first histogram.

In block 610, optionally, a coincident event is detected. In some embodiments, the coincident event is detected by the coincident detector.

In block 615, a fine time is output with the delay line. In some embodiments, the delay line is configured to output the one or more photons at a second resolution, where the counter is further configured to generate a second histogram of the one or more photons at the second resolution.

In block 620, the SRAM addressed by the delay line is read.

In block 625, data+1 is written back to the SRAM to form a second histogram (or fine histogram). In some embodiments, the second histogram has a second resolution. In some embodiments, the second resolution is higher than the first resolution. In some embodiments, the second histogram is a fine histogram.

In block 630, each fine histogram formed is read.

In block 635, each fine histogram is processed. In some embodiments, the global histogram processor configured to detect a peak of the second histogram, wherein a location of the peak of the second histogram determines a distance between the sensor and the target.

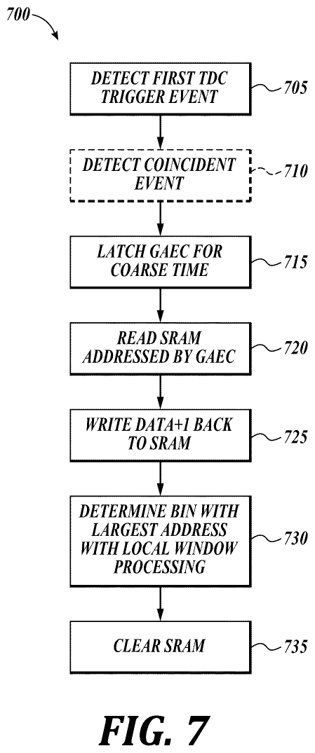

FIG. 7 is yet another example method of calculating a time of flight (ToF) measurements, in accordance with the present technology. In some embodiments, the method 700 is carried out with an image sensor (such as image sensor 100). In some embodiments, the image sensor includes a single photon avalanche diode (SPAD) controller (such as SPAD controller 101), a plurality of latches (such as plurality of latches 102A, 102B, 102C . . . 102D), a memory (such as memory 103), a window memory (such as window memory 104), a local window processer (such as local window processor 110), a delay line (such as delay line 107), a counter (such as counter+1), a calibrator (such as calibrator 111) and a plurality of single photon avalanche photodiodes (SPADs) (such as plurality of SPADs 108A, 108B, 108C . . . 108N).

In block 705, a first TDC trigger even is detected. In some embodiments, the first TDC trigger event includes one or more photons detected as an initial pulse of light of the plurality of pulses of light is reflected to the one or more SPADs. In some embodiments, the pulse of light is emitted by a laser (such as laser 120).

In block 710, optionally, a coincident event is detected. In some embodiments, the coincident event is detected by a coincident detector (such as coincident detector 109).

In block 715, Gray automatic exposure code (GAEC) is latched for coarse time. In some embodiments, one or more latches are configured to latch Gray automatic exposure code (GAEC) from the one or more SPADs, where the GAEC is associated with the first TDC trigger event.

In block 720, static random-access memory (SRAM) addressed by the GAEC is addressed. In some embodiments, the memory is configured to read the SRAM addressed by the GAEC.

In block 725, data+1 is written back to the SRAM to form a first histogram. In some embodiments, the first histogram has a first resolution. In some embodiments, the first histogram is a coarse histogram. In some embodiments, the counter is configured to count the one or more photons of the first TDC trigger event and generate a first histogram of the one or more photons at a first resolution.

In block 730, a bin with the largest address is determined with local window processing. In some embodiments, this means no histogram is formed.

In block 735, the SRAM is cleared.

It should be understood that all methods 500, 600, and 700 should be interpreted as merely representative. In some embodiments, process blocks of all methods 500, 600, 700, and 800 may be performed simultaneously, sequentially, in a different order, or even omitted, without departing from the scope of this disclosure.

What is claimed is:

1. A sensor for determining time of flight (ToF), the sensor comprising:
one or more single photon avalanche diodes (SPADs) configured to detect a first time to digital conversion (TDC) trigger event, wherein the first TDC trigger event includes one or more photons generated as an initial pulse of light of a plurality of pulses of light that interacts with the one or more SPADs, wherein the plurality of pulses is emitted by a source of light;
one or more latches configured to latch a code from the one or more SPADs, wherein the code is associated with the first TDC trigger event;
a memory configured to read static random-access memory (SRAM) addressed by the code;
a counter configured to count the one or more photons of the first TDC trigger event and generate a first histogram of the one or more photons at a first resolution;
a global window processor configured to read the first histogram and detect a peak of the first histogram;
a window memory configured to control a single photon avalanche diode (SPAD) controller, wherein the SPAD controller enables the one or more SPADs to detect a second TDC trigger event, wherein the second TDC trigger event includes one or more photons detected as an additional pulse of light of the plurality of pulses of light that interacts with the one or more SPADs during a time span of the peak of the first histogram;
a delay line configured to delay the propagation of the one or more photons by a predetermined time at a second resolution, wherein the counter is further configured to generate a second histogram of the one or more photons at the second resolution, and
a global histogram processor configured to detect a peak of the second histogram, wherein the peak of the second histogram determines a distance between the sensor and a target.

2. The sensor of claim 1, further comprising the source of light, wherein the source of light is a laser.

3. The sensor of claim 1, wherein the second resolution is higher than the first resolution.

4. The sensor of claim 1, further comprising arithmetic logic configured to detect one or more coincident event, wherein the code is further based on the one or more coincident event.

5. The sensor of claim 1, wherein each SPAD of the one or more SPADs is communicatively coupled to an active quenching circuit.

6. The sensor of claim 1, wherein the one or more SPADs are four SPADs.

7. The sensor of claim 6, wherein the four SPADs are arranged in a two-by-two array.

8. The sensor of claim 1, wherein the delay line is selected from a high-speed CLK counter and a low-speed CLK counter.

9. The sensor of claim 1, wherein the delay line is coupled with a 5-bit ripple counter.

10. The sensor of claim 1, wherein the global histogram processor is further configured to determine the peak of the second histogram with histogram centroid processing.

11. The sensor of claim 1, wherein the target comprises a first target and a second target.

12. The sensor of claim 11, wherein the first histogram comprises a first target histogram and a second target histogram, wherein the first target histogram is associated with the first target and the second target histogram is associated with the second target.

13. The sensor of claim 12, wherein the second histogram comprises the first target histogram at the second resolution and the second target histogram at the second resolution.

14. The sensor of claim 13, wherein a peak of the first target histogram at the second resolution and a peak of the second target histogram at the second resolution are compared to calculate a distance between the first target and the second target.

15. A method of calculating a time of flight (ToF) measurement, the method comprising:
detecting a first time to digital conversion (TDC) trigger event with one or more single photon avalanche diodes (SPADs), wherein the first TDC trigger event includes one or more photons detected as an initial pulse of light of a plurality of pulses of light is reflected to the one or more SPADs;
latching Gray automatic exposure code (GAEC) from the one or more SPADs, wherein the GAEC is associated with the first TDC trigger event with a plurality of latches;
reading static random-access memory (SRAM) addressed by the GAEC with a memory;
counting the one or more photons of the first TDC trigger event with a counter;
generating a first histogram of the one or more photons at a first resolution;
reading the first histogram to detect a peak range of the first histogram;
detecting a second TDC trigger event with the one or more SPADs, wherein the second TDC trigger event includes one or more photons detected as an additional pulse of light of the plurality of pulses of light is reflected to the one or more SPADs during the peak of the first histogram;
delaying propagation of the one or more photons at a second resolution with a delay line;
generating a second histogram of the one or more photons at the second resolution with the counter based on the delayed propagation of the one or more photons at a second resolution; and
detecting a peak of the second histogram.

16. The method of claim 15, wherein the second resolution is higher than the first resolution.

17. The method of claim 15, wherein the method further comprises:
detecting a coincident event with arithmetic logic, wherein the GAEC is further based on the coincident event.

18. The method of claim 15, wherein detecting the peak of the second histogram comprises:
applying a K-filter the second histogram;
convoluting the second histogram; and
determining the peak of the second histogram with a histogram centroid algorithm.

19. The method of claim 15, wherein the method further comprises determining a distance between the sensor and a target with the peak of the second histogram.

20. The method of claim 19, wherein the target comprises a first target and a second target, wherein the first histogram comprises a first target histogram and a second target histogram, wherein the first target histogram is associated with a first target and the second target histogram is associated with a second target, and wherein the second histogram comprises the first target histogram at the second resolution and the second target histogram at the second resolution, and wherein the method further comprises:
comparing a peak of the first target histogram at the second resolution with a peak of the second target histogram at the second resolution; and
determining a distance between the first target and the second target.
